(19) United States
(12) Patent Application Publication
(10) Pub. No.: US 2013/0152867 A1
(43) Pub. Date: Jun. 20, 2013

(54) Pet Barrier With Adjustable Hinges

(71) Applicants: Daisuke Kaneda, Tokyo (JP); Shigefumi Akimoto, Toyama City (JP); Terutoki Kobayashi, Toyama City (JP); Shingi Otani, Toyama City (JP)

(72) Inventors: Daisuke Kaneda, Tokyo (JP); Shigefumi Akimoto, Toyama City (JP); Terutoki Kobayashi, Toyama City (JP); Shingi Otani, Toyama City (JP)

(73) Assignee: RICHELL CORPORATION, Toyama City (JP)

(21) Appl. No.: 13/606,015

(22) Filed: Sep. 7, 2012

(30) Foreign Application Priority Data
Dec. 14, 2011 (JP) 2011-273529
Dec. 21, 2011 (JP) 2011-280140

(51) Int. Cl. A01K 1/00

(52) U.S. Cl. 119/502

(57) ABSTRACT

A pet barrier is disclosed. The pet barrier comprises a plurality of hinges. Each of the plurality of hinges a first component configured to engage a second component. The first component comprises one or more projections. The second component comprises a plurality of openings at a plurality of angles. One or more of the plurality of openings are configured to engage and lock the one or more projections at one of the plurality of angles. The pet barrier also comprises a plurality of panels. Each of the plurality of panels are configured to couple to another one of the plurality of panels at one of the plurality of angles via one of the plurality of hinges. The one of the plurality of hinges is locked at the one of the plurality of angles while the one or more of the plurality of openings engage the one or more projections.

### CROSS-REFERENCE TO RELATED APPLICATIONS

This application claims priority to Patent Application Serial No. 2011-273529, entitled “Convertible Indoor/Outdoor Pet Playpen”, filed with the Japan Patent Office on Dec. 14, 2011 and also claims priority to Patent Application Serial No. 2011-280140, entitled “Premium Plus Freestanding Pet Gate with Door”, filed with the Japan Patent Office on Dec. 21, 2011 under the Paris Convention for the Protection of Industrial Property.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE DISCLOSURE

This disclosure relates to a pet barrier with adjustable hinges for restricting the movement of a pet.

### BACKGROUND OF THE DISCLOSURE

Sometimes owners of pets will use pet barriers to prevent their pets from having the run of the house. For example, an owner may use a pet pen to enclose an animal or a pet gate to keep an animal in a certain area of a home.

### SUMMARY OF THE DISCLOSURE

In an embodiment of the disclosure, a pet barrier is disclosed. The pet barrier comprises a plurality of hinges. Each of the plurality of hinges a first component configured to engage a second component. The first component comprises one or more projections. The second component comprises a plurality of openings at a plurality of angles. One or more of the plurality of openings are configured to engage and lock the one or more projections at one of the plurality of angles. The pet barrier also comprises a plurality of panels. Each of the plurality of panels are configured to couple to another one of the plurality of panels at one of the plurality of angles via one of the plurality of hinges. The one of the plurality of hinges is locked at the one of the plurality of angles while the one or more of the plurality of openings engage the one or more projections.

In another embodiment of the disclosure, a pet barrier is disclosed. The pet barrier comprises a front panel comprising front panel door frame members and a door within the front panel door frame members. The front panel door frame members comprise a first vertical front panel door frame member about which the door rotates, a second vertical front panel door frame member, and a horizontal front panel door frame member. The second vertical front panel door frame member and the horizontal front panel door frame member each comprise an inset portion configured to receive a portion of the door when the door is in a closed state. The second vertical front panel door frame member further comprises a retractable component that is configured to protrude beyond the second vertical front panel door frame member and lock the door in the closed state. The door comprises a top horizontal door frame member. The top horizontal door frame member comprises a depression. The retractable component is configured to lock the door in the closed state by blocking the depression from vertical movement beyond the retractable component. The pet barrier also comprises at least two side panels. Each of the two side panels are configured to couple to the front panel via a hinge.

In yet another embodiment, a freestanding pet barrier is disclosed. The freestanding pet barrier comprises a plurality of hinges. Each of the plurality of hinges comprises a first component configured to engage a second component. The first component comprises one or more projections. The second component comprises a plurality of openings at a plurality of angles. One or more of the plurality of openings are configured to engage the one or more projections at one of the plurality of angles. The freestanding pet barrier also comprises a front panel and two side panels. Each of the two side panels is configured to couple the front panel at one of the plurality of angles via one of the plurality of hinges. The freestanding pet barrier is configured to form an open configuration that is self-supporting in use and a plan view of the freestanding pet barrier in the open configuration defines a non-enclosing figure.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a perspective view of an embodiment of a pet barrier with adjustable hinges.

FIG. 2A is a perspective view of one embodiment of a front panel illustrating the door in a closed and locked state.

FIG. 2B is a zoomed in perspective view of one embodiment of a front panel illustrating the door in a closed and locked state.

FIG. 2C is a perspective view of one embodiment of a front panel illustrating the door in an unlocked and open state.

FIG. 3A is a perspective view of an embodiment of a top hinge.

FIG. 3B is an exploded perspective view of an embodiment of a top hinge.

FIG. 4A is perspective view of an embodiment of a bottom hinge.

FIG. 4B is an exploded perspective view of an embodiment of a bottom hinge.

FIG. 5A is a perspective view of another embodiment of a pet barrier with adjustable hinges.

FIG. 5B is a perspective view of yet another embodiment of a pet barrier with adjustable hinges.

FIG. 5C is a perspective view of yet another embodiment of a pet barrier with adjustable hinges.

FIG. 5D is a perspective view of yet another embodiment of a pet barrier with adjustable hinges.

FIG. 6A is an exploded perspective view of an embodiment of a pet barrier with adjustable hinges.

FIG. 6B is an exploded perspective view of another embodiment of a pet barrier with adjustable hinges.

FIG. 6C is an exploded perspective view of yet another embodiment of a pet barrier with adjustable hinges.

FIG. 7A is a perspective view of one embodiment of a front panel illustrating the door in a closed state.

FIG. 7B is a perspective view of one embodiment of a front panel illustrating the door in an open state.

### DETAILED DESCRIPTION OF THE PREFERRED EMBODIMENTS

It should be understood at the outset that although illustrative implementations of one or more embodiments are illustrated below, the disclosed systems and methods may be implemented using any number of techniques, whether currently known or not yet in existence.

The disclosure should in no way be limited to the illustrative implementations, drawings, and techniques illustrated below, but may be modified within the scope of the appended claims along with their full scope of equivalents.

The disclosure provides a pet barrier with adjustable hinges that may be used to restrict the movement of pets. In an embodiment, the adjustable hinges comprise a plurality of fixed stops at a plurality of angles. The pet barrier may comprise a plurality of panels and each of the plurality of panels may be configured to couple to another one of the plurality of panels at one of the plurality of angles via one of the adjustable hinges. In an embodiment, the adjustable hinges enable fine adjustment of the plurality of panels of the pet barrier relative to each other, thereby allowing the pet barrier to better fit any desired space. For example, the adjustable hinges may enable adjustments of approximately less than ten degrees or approximately less than five degrees.

The pet barrier disclosed herein may be a freestanding pet gate, a pet pen, or a freestanding room divider. In an embodiment, the adjustable hinges enable the pet barrier to convert between a freestanding room divider, a freestanding gate, and a pen. For example, the adjustable hinges may have fixed stops at approximately 90, 180, and 240 degrees to enable the plurality of conversions. A single pet barrier with multiple functions like one embodiment of the pet barrier disclosed herein may be more economical for a consumer.

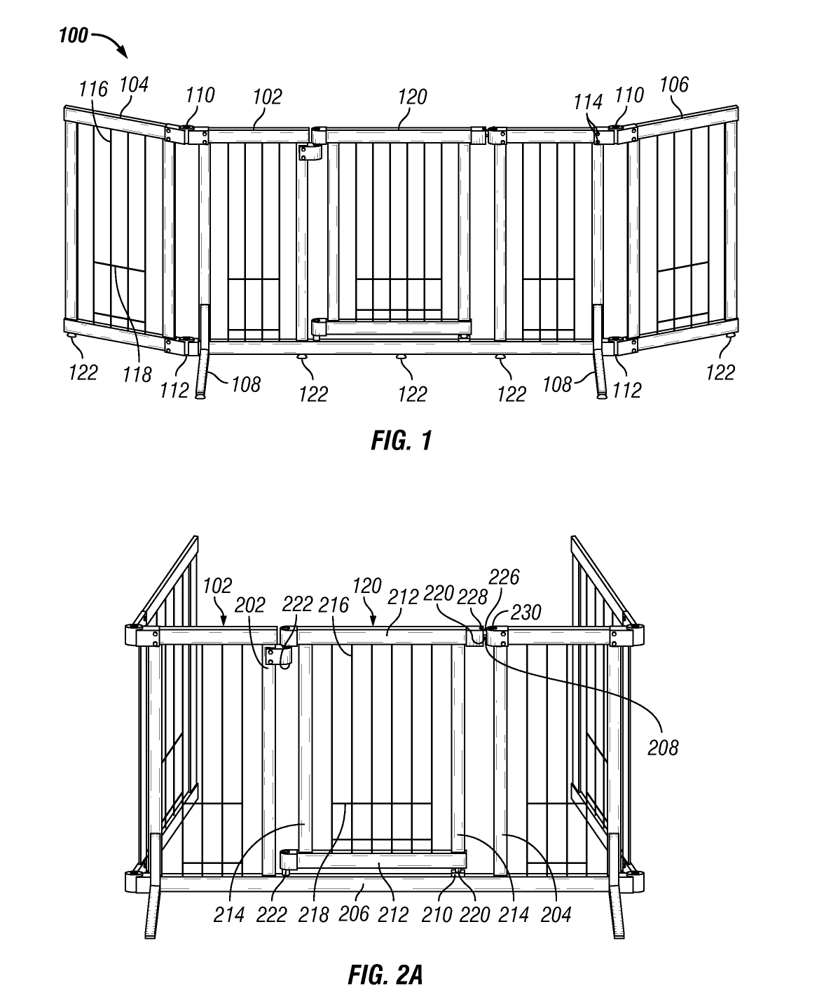

FIGS. 1-4 illustrate an embodiment of a pet barrier with adjustable hinges. In particular, FIG. 1 illustrates a freestanding pet barrier 100. The freestanding pet barrier 100 may be configured to form an open configuration that is self-supporting in use. Additionally, a plain view of the freestanding pet barrier 100 in the open configuration may define a non-enclosing figure.

The freestanding pet barrier 100 may comprise a plurality of panels 102, 104, and 106, a plurality of legs 108, a plurality of top hinges 110, and a plurality of bottom hinges 112. In an embodiment, the plurality of panels comprises a front panel 102, a first side panel 104, and a second side panel 106. The first side panel 104 and the second side panel 106 may be configured to couple to the front panel 102 at a plurality of angles via the plurality of top hinges 110. Coupled as used herein means directly or indirectly connected. Additionally, the first side panel 104 and the second side panel 106 may be configured to couple to the front panel 102 via the plurality of bottom hinges 112. The plurality of top hinges 110 and the plurality of bottom hinges 112 may be made of plastic or another material. Each of the plurality of top hinges 110 and the plurality of bottom hinges 112 may be configured to couple to two of the plurality of panels 102, 104, and 106 via one or more connector 114. The connector 114 may comprise screws, bolts, and/or another connection member.

In an embodiment, the front panel 102, the first side panel 104, and the second side panel 106 comprise a plurality of vertical members 116. Further, the front panel 102, the first side panel 104, and the second side panel 106 may comprise one or more horizontal members 118. The plurality of vertical members 116 and the one or more horizontal members 118 may be wires. Alternatively, the plurality of vertical members 116 and the one or more horizontal members 118 may be wooden bars or plastic bars. In any embodiment, the plurality of vertical members 116 and the one or more horizontal members 118 may be generally planar, generally cylindrical, or generally another three dimensional shape such as a triangular prism or a quadrangular prism. One of ordinary skill in the art will appreciate that the plurality of vertical members 116 and the one or more horizontal members 118 may be other shapes without departing from the scope of the disclosure. In addition to or in place of the plurality of vertical members 116 and the one or more horizontal members 118, a plastic panel or cloth may be used.

The plurality of legs 108 may be configured to couple to the front panel 102. For example, the plurality of legs 108 may be configured to couple to the front panel 102 via one or more connection members (not shown), such as one or more screws or bolts, for example. In an embodiment, the plurality of legs 108 may connect to front panel 102 (i.e., directly couple to the front panel 102). Alternatively, each of the plurality of legs 108 may connect to one of the first and second side panels 102, 104, which connect to the front panel 102 (i.e., indirectly couple to the front panel 102). The plurality of legs 108 may be configured to couple to and extend from one side of the front panel 102 while the first side panel 104 and the second side panel 106 may be configured to couple to and extend from the other side of the front panel 102. In an embodiment, the plurality of legs 108 is made of wood. Alternatively, the plurality of legs 108 may be made of plastic or another material. The plurality of legs 108 may be of such a size and shape that they do not obstruct a path of a pet. In an embodiment, the plurality of legs 108 increases stability when the indoor freestanding pet barrier 100 stands alone.

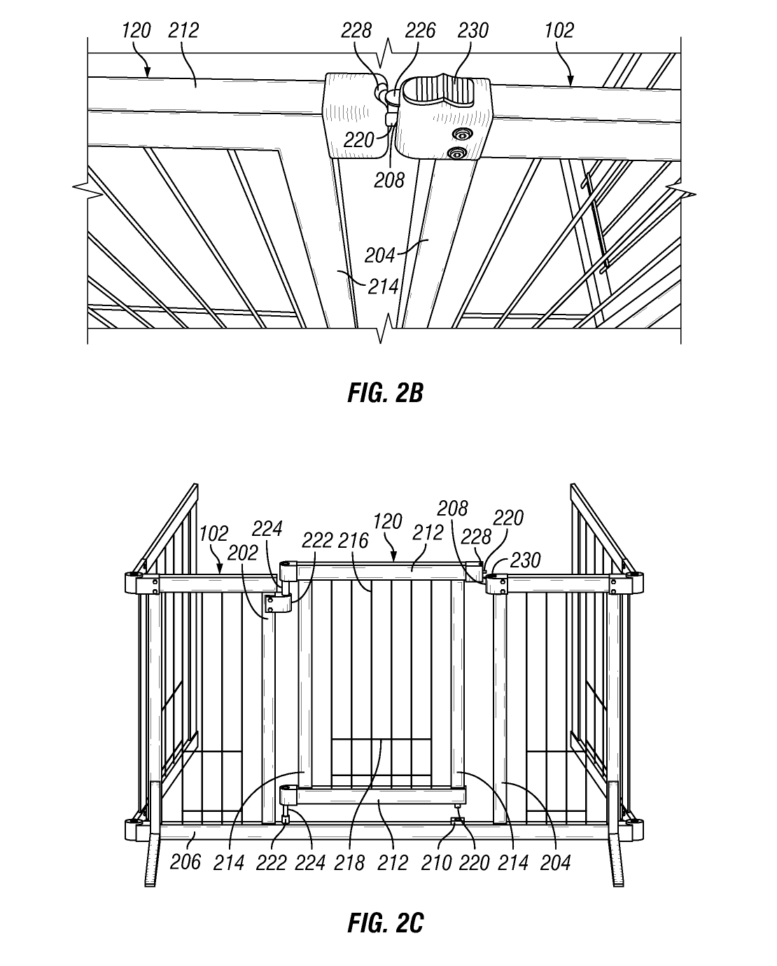

The front panel 102 may comprise a door 120 at approximately the middle of the front panel 102. FIGS. 2A-2C illustrate the front panel 102 in more detail. Besides the door 120, the front panel 102 may also comprise front panel door frame members 202, 204, and 206. For example, the front panel 102 may comprise a first vertical front panel door frame member 202 about which the door 120 rotates, a second vertical front panel door frame member 204, and a horizontal front panel door frame member 206. In an embodiment, the door 120 is situated within the front panel door frame members 202, 204, and 206. The front panel door frame members 202, 204, and 206 may be made out of wood, plastic, metal, or any combination thereof.

In an embodiment, a portion 208 of the second vertical front panel door frame member 204 is inset. Also, a portion 210 of the horizontal front panel door frame member 206 may be inset. As will be discussed in more detail below, in an embodiment, both inset portions 208 and 210 help to keep the door 120 in the closed position by maintaining a portion of the door 120 (e.g., retractable pegs 220) within the inset portions 208, 210.

The door 120 may comprise a plurality of horizontal door frame members 212 and a plurality of vertical door frame members 214. The horizontal door frame members 212 and the vertical door frame members 214 may be made out of wood, plastic, metal, or any combination thereof. In an embodiment, the door 120 comprises a plurality of vertical door members 216 and one or more horizontal door members 218. The vertical door members 216 and the one or more horizontal door members 218 may be wires. Alternatively, the vertical door members 216 and the one or more horizontal door members 218 may be wooden bars or plastic bars. In any embodiment, the vertical door members 216 and the one or more horizontal door members 218 may be generally planar, generally cylindrical, or generally another three dimensional shape such as a triangular prism or a quadrangular prism. One of ordinary skill in the art will appreciate that the vertical door members 216 may be other shapes without departing from the scope of the disclosure.

In an embodiment, the door 120 comprises a plurality of retractable pegs 220. For example, as is illustrated in FIGS. 2A and 2B, the door 120 may comprise two retractable pegs 220. One of the retractable pegs 220 may be coupled to an end of one of the horizontal door frame members 212. Specifically, one of the retractable pegs 220 may be coupled to the end of the top horizontal door frame member 212 farthest from the axis upon which the door 120 rotates. In an embodiment, the other of the retractable pegs 220 is coupled to a bottom of one of the horizontal door frame members 212. In particular, the other of the retractable pegs 220 may be coupled to the bottom of the bottom horizontal door frame member 212. The retractable pegs 220 may be positioned such that when the door 120 is in the closed position one of the retractable pegs 220 is contained within the inset portion 208 and the other of the retractable pegs 220 is contained within the inset portion 210, which may help maintain the door 120 in the closed position. In an embodiment, the retractable pegs 220 are made from plastic, wood, metal, or any combination thereof.

The door 120 may be coupled to the horizontal front panel door frame member 206 and the first vertical front panel door frame members 202. For example, the bottom horizontal door frame member 212 may be coupled to the horizontal front panel door frame member 206 by one of a plurality of connectors 222 and the top horizontal door frame members 212 may be coupled to the first vertical front panel door frame member 202 by another one of the plurality of connectors 222. In an embodiment, the plurality of connectors 222 comprises screws, pins, or another type of connector. The plurality of connectors 222 may be of a length that enables a play allowance 224. This play allowance 224 is illustrated in FIG. 2C, which shows the door 120 in an unlocked and open position. In an embodiment, the play allowance 224 enables the door 120 to be raised so that the retractable pegs 220 can be removed from the inset portions 208 and 210 and the door 120 can be opened.

The front panel 102 may also comprise a retractable component 226. In an embodiment, the retractable component 226 is coupled to the second vertical front panel door frame member 204. The retractable component 226 may protrude beyond the second vertical front panel door frame member 204 and lock the door 120 in a closed state. For example, the top horizontal door frame member 212 may comprise a depression 228 and the retractable component 226 may be configured to lock the door 120 in the closed state by blocking the depression 228 from vertical movement beyond the retractable component 226. The retractable component 226 may be made of plastic, wood, metal, or another material. FIGS. 2A and 2B illustrate the retractable component 226 in an extended state, thereby locking the door 120 in a closed state.

The second vertical front panel door frame member 204 may also comprise an actuator 230 to enable retraction of the retractable component 226 and opening of the door 120. In an embodiment, the retractable component 226 is refracted and the door 120 is unlocked by moving the actuator 230 away from the retractable component. For example, the actuator 230 may be moved with a user's thumb or other finger. After moving the actuator 230 to retract the retractable component 226 and while the retractable component 226 is in the retracted state, the user may lift up on the door 120, thereby opening the door 120 as illustrated in FIG. 2C. One of ordinary skill in the art will appreciate that the retractable component 226 may be retracted in other ways without departing from the scope of the disclosure.

In an embodiment, the freestanding pet barrier 100 also comprises a plurality of supports 122 on the bottom side of the freestanding pet barrier 100. For example, the front panel 102 may comprise three supports 122, each of the first side panel 104 and the second side panel 106 may comprise one support 122, and each of the plurality of legs 108 may comprise one support 122. In an embodiment, the front panel 102 comprises at least one support 122 at approximately the center or middle of the bottom side of the front panel 102, which is aligned with approximately the center or middle of door 120. For instance, the front panel may comprise at least one support 122 within at least one inch of the center or middle of the front panel 102. This at least one support 122 may help to keep the door square within the door frame such that the inset portions 208 and 210 engage the pegs 220 when the door 120 is in the closed position.

The plurality of supports 122 may be made of rubber, plastic, or another material. The plurality of supports 122 may provide an even floor contacting surface for the freestanding pet barrier 100. Additionally, the plurality of supports may prevent the plurality of panels 102, 104, and 106 from sliding on a flooring surface and/or scratching the flooring surface upon which the freestanding pet barrier 100 is placed.

Although not illustrated in FIGS. 2A-2C, the front panel 102 may be expandable and contractible in the width direction. For example, the front panel 102 may comprise a plurality of front panels that are positioned such that they overlap with each other in the anteroposterior direction and the total width of the front panel 102 can be adjusted by adjusting the length of the overlapping.

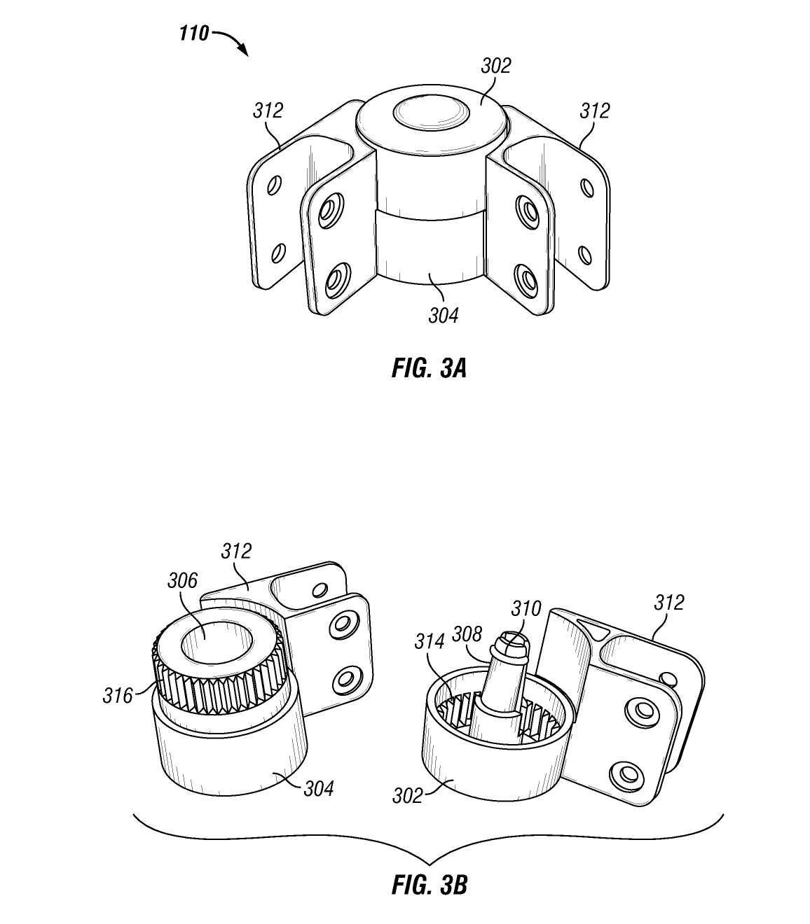

FIGS. 3A and 3B illustrate one of the plurality of top hinges 110 in more detail. The plurality of top hinges 110 may comprise a first component 302 and a second component 304. In an embodiment, the first component 302 is configured to engage or fit atop the second component 304 as is shown in FIG. 3A. For example, the second component 304 may comprise a receiving member 306 such as a hole that is configured to receive an arm 308 of the first component 302. In an embodiment, the arm 308 comprises a lip 310 to prevent the arm 308 from being removed from the receiving member 306 when the first component 302 is lifted to adjust the top hinge 110 to a different angle.

The first component 302 and the second component 304 may each comprise a connection member 312 to enable the first component 302 to couple to one of the plurality of panels 102, 104, and 106 and the second component 304 to couple to another of the plurality of panels 102, 104, and 106. Connectors 114 discussed above with respect to FIG. 1 may be inserted through the connection members 312 to secure the coupling. The connection members 312 may be positioned such they limit or prevent movement of the plurality of top hinges 110 beyond 180 degrees, thereby limiting or preventing movement of the plurality of panels 102, 104, and 106 relative to each other beyond 180 degrees.

In an embodiment, the plurality of top hinges 110 comprise a plurality of fixed stops at a plurality of angles to enable the plurality of panels 102, 104, and 106 to couple to another one of the plurality of panels 102, 104, and 106 at one of the plurality of angles. For example, the first component 302 may comprise one or more projections 314 and the second component 304 may comprise a plurality of openings 316. One or more of the plurality of openings 316 may be configured to engage the one or more projections 314 depending on the preferred angle of the plurality of panels 102, 104, and 106. The plurality of openings 316 may be defined by a support or wall on either side of each opening. The one or more projections 314 of the first component 302 are configured to fit within one or more of the plurality of openings 316 of the second component 304 such that when engaged the one or more projections 314 are stopped from further movement by the support or wall on either side of the one or more of the plurality of openings 316. In another embodiment, each of the plurality of openings 316 is the space between two projections such as in FIG. 3B. In such an embodiment, the one or more projections 314 of the first component 302 are configured to fit within one or more of the plurality of openings 316 of the second component 304 such that when engaged the one or more projections 314 are stopped from further movement by the projections on either side of the one or more of the plurality of openings 316.

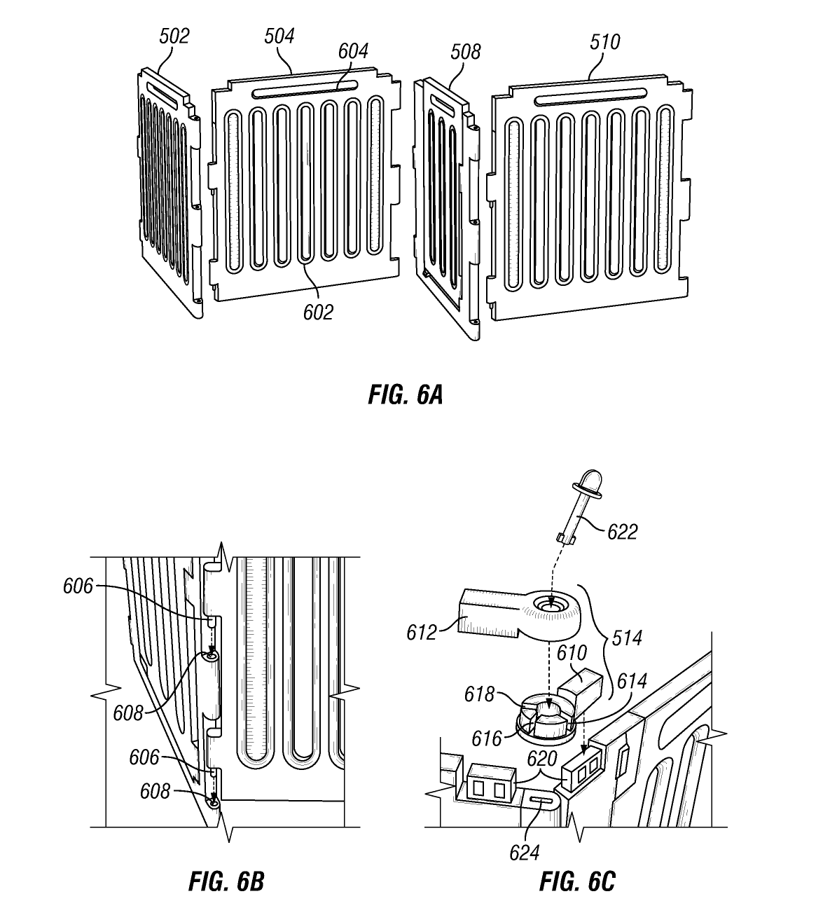

In one embodiment, the one or more projections 314 are pie shaped projections and the plurality of openings 316 are pie shaped slots. In another embodiment, the one or more projections 314 are square or rectangular shaped extensions and the plurality of openings 316 are slots. This embodiment is described in more detail below in FIG. 6C. In yet another embodiment, as illustrated in FIG. 3B, the one or more extensions 314 and the plurality of openings 316 are near equal sized teeth. One advantage to having a plurality of projections rather than just a single projection is that the hinge would provide a more stable, secure connection for plurality of panels 102, 104, and 106.

In an embodiment, as illustrated in FIG. 3B, the number of projections 314 on the first component 302 equals the number of openings 316 on the second component 304. In such an embodiment, the one or more projections 314 on the first component 302 and the one or more openings 316 on the second component 304 may be approximately equally spaced from the next projection 314 or opening 316. Alternatively, the first component 302 and the second component 304 may comprise a different number of projections 314 and openings 316.

In an embodiment, the plurality of top hinges 110 comprises at least ten fixed stops. For example, the second component 304 comprises at least ten openings and the first component 302 comprises one or more projections. In such an embodiment, each of the at least ten openings may be approximately 10 degrees from another of the at least ten openings. For example, each of the at least ten openings may be 8 to 12 degrees from another of the at least ten openings. In another embodiment, the second component 304 comprises at least twenty openings and the first component comprises one or more projections. In such an embodiment, each of the at least twenty openings may be approximately 5 degrees from another of the at least twenty openings. For example, each of the at least twenty openings may be 3 to 7 degrees from another of the at least twenty openings.

In order to adjust the top hinge 110 to another of the plurality of angles enabled by the one or more projections 314 and the plurality of openings 316, the first component 302 may be lifted and rotated to a different angle. Once the appropriate angle is reached, the first component 302 may be pushed down to fully engage the second component 304 such that the one or more projections 314 are engaged in one or more of the plurality of openings 316, thereby locking the top hinge 110 in place at that angle.

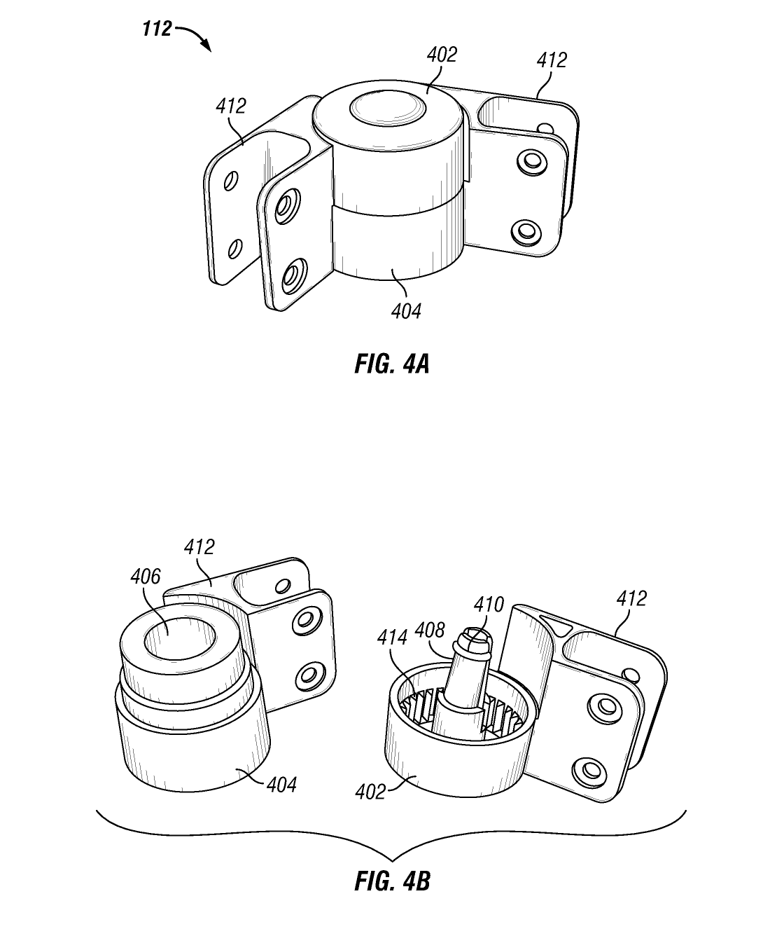

FIGS. 4A and 4B illustrate one of the plurality of bottom hinges 112 in more detail. The plurality of bottom hinges 112 may comprise a first component 402 and a second component 404. In an embodiment, the first component 402 is configured to engage or fit atop the second component 404 as is shown in FIG. 4A. For example, the second component 404 may comprise a receiving member 406 such as a hole that is configured to receive an arm 408 of the first component 402. In an embodiment, the arm 408 comprises a lip 410 to prevent the arm 408 from being removed from the receiving member 406 when the first component 302 of the top hinge 110 is lifted to adjust the top hinge 110 and the bottom hinge 112 to a different angle.

The first component 402 and the second component 404 may each comprise a connection member 412 to enable the first component 402 to couple to one of the plurality of panels 102, 104, and 106 and the second component 404 to couple to another of the plurality of panels 102, 104, and 106. Connectors 114 discussed above with respect to FIG. 1 may be inserted through the connection members 412 to secure the coupling. The connection members 412 may be positioned such they limit or prevent movement of the plurality of bottom hinges 112 beyond 180 degrees, thereby limiting or preventing movement of the plurality of panels 102, 104, and 106 relative to each other beyond 180 degrees.

In an embodiment, each of the plurality of bottom hinges 112 is continuously adjustable. For example, at least one of the first component 402 and the second component 404 is smooth with no fixed stops or teeth. While illustrated in FIG. 4B as comprising a plurality of teeth 414, the first component 402 could alternatively be smooth (i.e., not comprise a plurality of teeth).

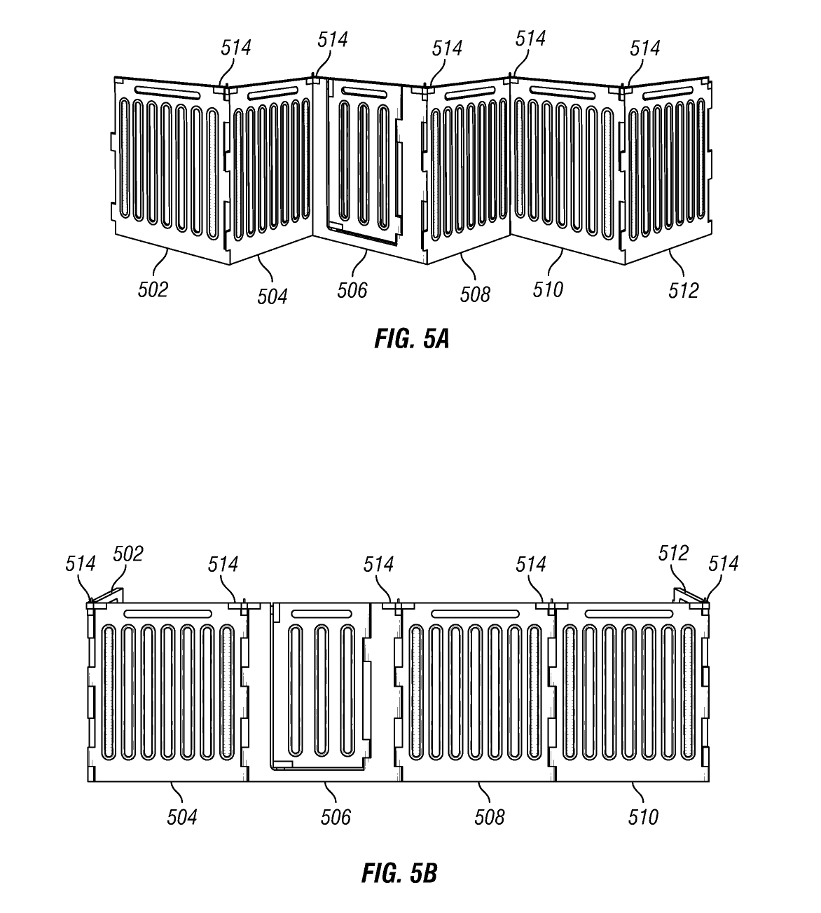

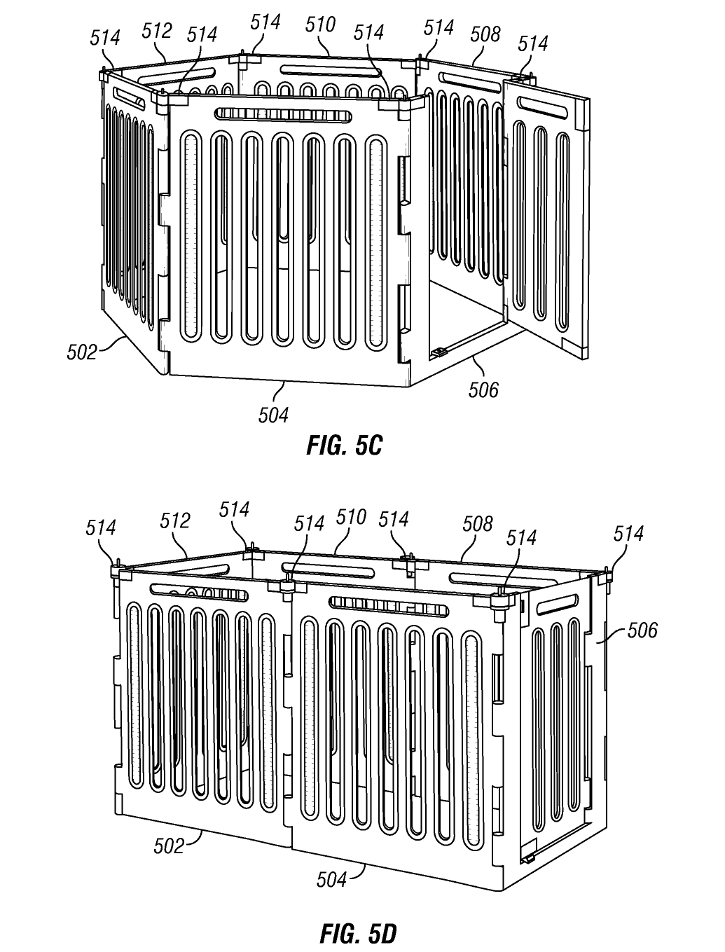

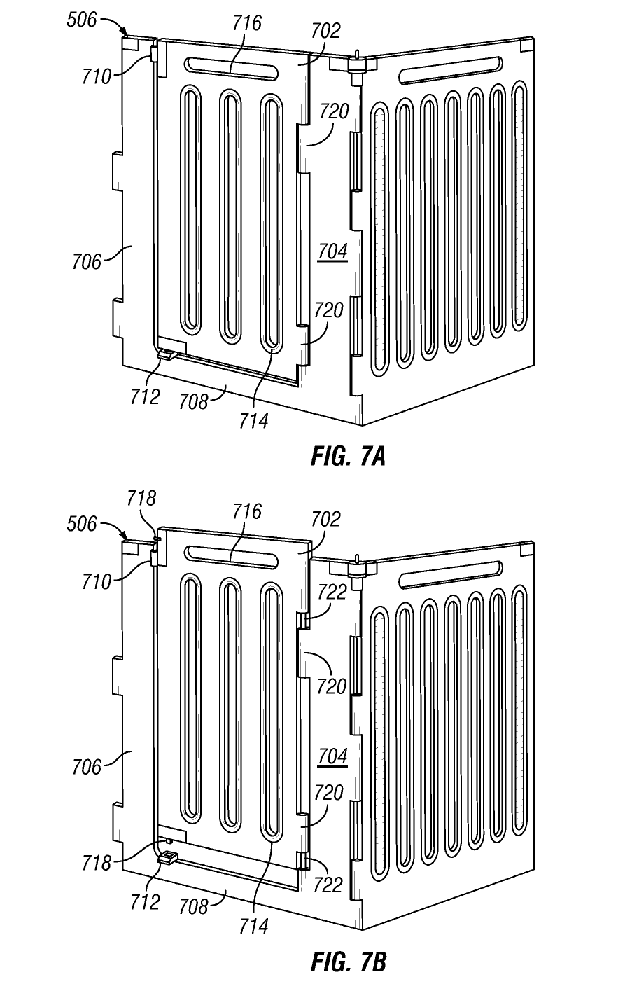

FIGS. 5-7 illustrate another embodiment of a pet barrier with adjustable hinges. Specifically, the pet barrier illustrated in FIGS. 5A-5D is “convertible” because it may be easily converted into a freestanding room divider as illustrated in FIG. 5A, a freestanding gate as illustrated in FIG. 5B, or a pen as illustrated in FIGS. 5C and 5D. Each of the embodiments of the pet barrier illustrated in FIGS. 5A-5D comprises a plurality of panels 502, 504, 506, 508, 510, and 512 and an adjustable hinge 514 between each of the plurality of panels. Panels 502, 504, 506, 508, 510, and 512 and adjustable hinges 514 will be described in greater detail below with regard to FIGS. 6A-6C. In an embodiment, one of the plurality of panels, such as panel 506, is an front panel. An embodiment of an front panel will be described in greater detail below with regard to FIGS. 7A and 7B. While six panels 502, 504, 506, 508, 510, and 512 are illustrated in FIGS. 5A-5D, one of ordinary skill in the art will appreciate that the convertible pet barrier may comprise a greater number of panels or a lesser number of panels without departing from the scope of the disclosure.

FIG. 5A illustrates an embodiment of a pet barrier with adjustable hinges. Particularly, as stated above, FIG. 5A illustrates a pet barrier as a freestanding room divider. In such an embodiment, the plurality of panels 502, 504, 506, 508, 510, and 512 are open and are non-self-enclosing. While each of the plurality of panels 502, 504, 506, 508, 510, and 512 are illustrated in FIG. 5A at approximately 90 degree angles from each other, one of ordinary skill in the art will appreciate that the angles between each of the plurality of panels 502, 504, 506, 508, 510, and 512 may be greater or less than approximately 90 degrees. Further, the angles between some of the plurality of panels 502, 504, 506, 508, 510, and 512 may be different.

FIG. 5B illustrates another embodiment of a pet barrier with adjustable hinges. Specifically, as stated above, FIG. 5B illustrates a pet barrier as a freestanding gate. In such an embodiment, the plurality of panels 502, 504, 506, 508, 510, and 512 are open and non-self-enclosing and define an open space. As illustrated in FIG. 5B, the plurality of panels 502, 504, 506, 508, 510, and 512 of the freestanding gate may be positioned relative to each other so as to resemble a letter “U”. Alternatively, the plurality of panels 502, 504, 506, 508, 510, and 512 of the pet barrier illustrated in FIG. 5B may be moved alone or in combination with additional panels in such a way so as to resemble a different letter, such as a “C”, a “V”, an “L”, or any other letter, or a shape, such as a triangle, a rectangle, a pentagon, a hexagon, a heptagon, an octagon, or any other shape.

FIGS. 5C and 5D illustrate yet other embodiments of a pet barrier with adjustable hinges. In particular, as stated above, FIGS. 5C and 5D illustrate a pet barrier as a pen. In such an embodiment, the plurality of panels 502, 504, 506, 508, 510, and 512 are self-enclosing, which means that the end panels couple together to form a closed loop. As illustrated in FIG. 5C, the plurality of panels 502, 504, 506, 508, 510, and 512 form a hexagonal pen. As illustrated in FIG. 5D, the plurality of panels 502, 504, 506, 508, 510, and 512 form a rectangular pen. Alternatively, the plurality of panels 502, 504, 506, 508, 510, and 512 may be moved alone or in combination with additional panels in such a way so as to form a pen in the shape of a triangle, a pentagon, a heptagon, an octagon, or any other shape.

Although not illustrated, in an embodiment, the pet barriers illustrated in FIGS. 5C and 5D comprises one or more top panels. Additionally, although not illustrated, the pet barriers illustrated in FIGS. 5C and 5D may also comprise a floor tray or mat.

Turning now to FIGS. 6A-6C, an exploded view of embodiments of a pet barrier with adjustable hinges are illustrated. More specifically, FIG. 6A illustrates an exploded view of four panels 502, 504, 508, and 510 of the plurality of panels 502, 504, 506, 508, 510, and 512 and FIG. 6B illustrates an exploded view of an embodiment of how two of the plurality of panels 502, 504, 506, 508, 510, and 512 couple together. Further, FIG. 6C illustrates an exploded view of an embodiment of an adjustable hinge.

Referring first to FIG. 6A, each of the plurality of panels 502, 504, 506, 508, 510, and 512 may be made of plastic and comprise a plurality of vertical cutouts 602 and one or more horizontal cutouts 604. The plurality of vertical cutouts 602 and one or more horizontal cutouts 604 may be oval shaped, rectangular shaped, or another shape altogether. The one or more horizontal cutouts 604 may also be used as handles to aid a user in moving the panels individually or the pet barrier as assembled. In alternative embodiments, the plurality of panels 502, 504, 506, 508, 510, and 512 comprise two horizontal frame members and two vertical frame members as well a plurality of vertical members and one or more horizontal members disposed there between. In such alternative embodiments, the plurality of panels 502, 504, 506, 508, 510, and 512 may be similar in structure to one or more of the panels described above with respect to FIG. 1.

In an embodiment, each of the plurality of panels 502, 504, 506, 508, 510, and 512 also comprise a plurality of stems 606 and a plurality of receiver holes 608 as shown in FIG. 6B. As is illustrated in FIG. 6B, to couple one of the plurality of panels 502, 504, 506, 508, 510, and 512 to another, each of the plurality of stems 606 of one of the plurality of panels 502, 504, 506, 508, 510, and 512 may be inserted into one of the plurality of receiver holes 608 of another of the plurality of panels 502, 504, 506, 508, 510, and 512.

In an embodiment, each end of the top of each of the plurality of panels 502, 504, 506, 508, 510, and 512 comprises a protrusion 620 as shown in FIG. 6C, which is configured to receive an adjustable hinge 514. The adjustable hinge 514 illustrated in FIG. 6C may comprise a first component 610 and a second component 612. In an embodiment, a portion of the first component 610 is configured to engage or fit atop a portion of the second component 610 as is by one of the arrows in FIG. 6C. For example, the round portion of the second component 612 may be configured to fit atop the round portion of the first component 610. While the first component 610 is illustrated in FIG. 6C as being configured to engage protrusion 620 of the right panel and the second component 612 is illustrated in FIG. 6C as being configured to engage protrusion 620 of the left panel, either component could be installed on either protrusion 620. For example, the first component 610 may engage protrusion 620 of the left panel and the second component 612 may engage protrusion 620 of the right side panel.

In an embodiment, the adjustable hinges 514 comprise a plurality of fixed stops at a plurality of angles to enable the plurality of panels 502, 504, 506, 508, 510, and 512 to couple to another one of the plurality of panels 502, 504, 506, 508, 510, and 512 at one of the plurality of angles. For example, the first component 610 may comprise a plurality of openings 614, 616, and 618 and the second component 612 may comprise a projection (not shown) on the inside of the round portion of the second component 612 that is configured to be received by one of the plurality of openings 614, 616, and 618. The plurality of openings 614, 616, and 618 may be slots and the projection may be a square or rectangular extension. In an embodiment, opening 614 is at approximately 90 degrees, opening 616 is at approximately 180 degrees, and opening 618 is at approximately 240 degrees. For instance, opening 614 may be at 80 to 100 degrees, opening 616 may be at one 170 to 190 degrees, and opening 618 may be at 230 to 250 degrees. Having the plurality of fixed stops/openings at approximately 90, 180, and 240 degrees may enable the conversion between the freestanding room divider, the freestanding gate, and/or the pen.

In an embodiment, when the first component is installed on the right panel as is illustrated in FIG. 6C, the angle between the panels may be approximately 90 degrees, approximately 180 degrees, or approximately 240 degrees. As discussed above, the first component 610 may instead be installed on the left side panel. Installing the first component 610 on the left side panel gives the user two additional angles possibilities (i.e., approximately 120 degrees and approximately 270 degrees). Thus, the interchangeability of the first component 610 and the second component 612 on either the right or left side panels and the three openings 614, 616, and 618 provides five different potential panel angles (i.e., approximately 90 degrees, approximately 120 degrees, approximately 180 degrees, approximately 240 degrees, and approximately 270 degrees).

After inserting each of the plurality of stems 606 into the corresponding receiver hole 608, two of the plurality panels 502, 504, 506, 508, 510, and 512 may positioned at an appropriate angle. For example, the panels may be positioned at approximately 90, 180, or 240 degrees from each other. In an embodiment, as is illustrated in FIG. 6C, the two panels are positioned at approximately 240 degrees from each other. Next, the first component 610 may be inserted onto one of the protrusions 620 of one of the plurality of panels 502, 504, 506, 508, 510, and 512. Subsequently, the second component 612 may be inserted onto a portion of the first component 610 (e.g., the round portion) and one of the protrusions 620 of another of the plurality of panels 502, 504, 506, 508, 510, and 512 such that the projection of the second component 612 is received by the appropriate opening 614, 616, or 618. The engagement of the projection of the second component 612 with the appropriate opening 614, 616, or 618 sets or locks the angle while the projection and the opening remain engaged. Finally, a pin 622 is inserted through the first and second components 610 and 612 into the pin receiver 624 of one of the plurality panels 502, 504, 506, 508, 510, and 512 and turned approximately 90 degrees so that the projection at the bottom of the pin 622 is locked within the pin receiver 622. In an embodiment, the pen 622 and the pin receiver 624 secure the adjustable hinge 514 to the corresponding two panels of the plurality of panels 502, 504, 506, 508, 510, and 512.

While illustrated as comprising only three fixed stops/openings in FIG. 6C, one of ordinary skill in the art would recognize that the adjustable hinge 514 may comprise more or less fixed stops/openings at different angles without departing from the scope of the disclosure. Furthermore, in alternative embodiments, instead of using stems 606 and receiver holes 608, each of the plurality of panels 502, 504, 506, 508, 510, and 512 may be configured to couple to another of the plurality of panels 502, 504, 506, 508, 510, and 512 via a bottom hinge such as the bottom hinge described above with respect to FIGS. 4A and 4B.

Turning now to FIGS. 7A and 7B, an embodiment of the front panel 506 is illustrated. The front panel 506 illustrated in FIGS. 7A and 7B may be similar to the front panel 102 described above with respect to FIGS. 2A-2C. For example, the front panel 506 may comprise a door 702 and front panel door frame members 704, 706, and 708. For example, the front panel 506 may comprise a first vertical front panel door frame member 704 about which the door 702 rotates, a second vertical front panel door frame member 706, and a horizontal front panel door frame member 708. In an embodiment, the door 702 is situated within the front panel door frame members 704, 706, and 708. The front panel door frame members 704, 706, and 708 may be made out of wood, plastic, metal, or any combination thereof. Also, the front panel door frame members 704, 706, and 708 may be a single front panel door frame (i.e., not individual members).

In an embodiment, a portion 710 of the second vertical front panel door frame member 706 is inset. Also, a portion 712 of the horizontal front panel door frame member 708 may be inset. As will be discussed in more detail below, in an embodiment, both inset portions 710 and 712 help to keep the door 702 in the closed position by maintaining a portion of the door 702 (e.g., retractable pegs 718).

The door 702 may be made of plastic and comprise a plurality of vertical cutouts 714 and one or more horizontal cutouts 716. The plurality of vertical cutouts 714 and one or more horizontal cutouts 716 may be oval shaped, rectangular shaped, or another shape altogether. In alternative embodiments, the door 702 may comprise two horizontal frame members and two vertical frame members as well a plurality of vertical members and one or more horizontal members disposed there between. In such alternative embodiments, the door 702 may be similar in structure to the door 120 described above with respect to FIGS. 2A-2C.

In an embodiment, the door 702 comprises a plurality of retractable pegs 718. For example, as is illustrated in FIG. 7B, the door 702 may comprise two retractable pegs 718. One of the retractable pegs 718 may be coupled to the side of the door 702. Specifically, one of the retractable pegs 718 may be coupled to the side of the door 702 farthest from the axis upon which the door 702 rotates. In an embodiment, the other of the retractable pets 718 is coupled to a bottom of the door 702. The retractable pegs 718 may be positioned such that when the door 702 is in the closed position one of the retractable pegs 718 is contained within the inset portion 710 and the other of the retractable pegs 718 is contained within the inset portion 712, which may help maintain the door 702 in the closed position. In an embodiment, the retractable pegs 718 are made from plastic, wood, metal, or any combination thereof.

The door 702 may be coupled to the horizontal front panel door frame member 708 and the first vertical front panel door frame members 704. For example, the door 702 may be coupled to the horizontal front panel door frame member 708 and the first vertical front panel door frame member 704 by a plurality of connectors 720. In an embodiment, the plurality of connectors 720 comprises screws, pins, or another type of connector. The plurality of connectors 720 may be of a length that enables a play allowance 722. This play allowance 722 is illustrated in FIG. 7B, which shows the door 702 in an open position. In an embodiment, the play allowance 722 enables the door 702 to be raised so that the retractable pegs 718 can be removed from the inset portions 710 and 712 and the door 702 can be opened.

Although not illustrated in FIGS. 7A and 7B, in an embodiment, the front panel 506 also comprises a retractable component similar to the retractable component 226 in FIGS. 2A-2C. In such an embodiment, the door 702 may also comprise a depression and the second vertical front panel door member 706 may also comprise an actuator similar to the depression 228 and the actuator 230 in FIGS. 2A-2C. This embodiment may provide an additional locking mechanism for the door 702.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A pet barrier comprising:
a plurality of hinges,
wherein each of the plurality of hinges comprise a first component configured to engage a second component,
wherein the first component comprises one or more projections,
wherein the second component comprises a plurality of openings at a plurality of angles, and
wherein one or more of the plurality of openings are configured to engage and lock the one or more projections at one of the plurality of angles; and
a plurality of panels, wherein each of the plurality of panels is configured to couple to another one of the plurality of panels at one of the plurality of angles via one of the plurality of hinges, and wherein the one of the plurality of hinges is locked at the one of the plurality of angles while the one or more of the plurality of openings engage the one or more projections.

2. The pet barrier of claim 1, wherein one of the plurality of panels comprises a door.

3. The pet barrier of claim 1, wherein the plurality of panels are coupled together to form a freestanding pet gate or a pet pen.

4. The pet barrier of claim 3, wherein the pet pen is square, rectangular, or hexagonal.

5. The pet barrier of claim 1, wherein the plurality of panels comprises at least three panels, and wherein the plurality of hinges comprises at least two hinges.

6. The pet barrier of claim 1, wherein the plurality of panels comprises at least four panels, and wherein the plurality of hinges comprises at least three hinges.

7. The pet barrier of claim 1, wherein the plurality of panels comprises at least six panels, and wherein the plurality of hinges comprises at least five hinges.

8. The pet barrier of claim 1, wherein the plurality of openings comprise at least a first slot, a second slot, and a third slot.

9. The pet barrier of claim 8, wherein the first slot is at approximately 90 degrees, the second slot is at approximately 180 degrees, and the third slot is at approximately 240 degrees.

10. The pet barrier of claim 1, wherein the plurality of openings of each of the plurality of hinges comprises at least ten openings, and wherein each of the at least ten openings is approximately ten degrees from another of the at least ten openings.

11. The pet barrier of claim 1, wherein the plurality of openings of each of the plurality of hinges comprises at least twenty openings, and wherein each of the at least twenty openings is approximately five degrees from another of the at least twenty openings.

12. The pet barrier of claim 1, further comprising a plurality of bottom hinges, wherein one of the plurality of panels is further configured to couple to another one of the plurality of panels via one of the plurality of bottom hinges, and wherein each of the plurality of bottom hinges is continuously adjustable.

13. A pet barrier comprising:
a front panel comprising front panel door frame members and a door within the front panel door frame members,
wherein the front panel door frame members comprise a first vertical front panel door frame member about which the door rotates, a second vertical front panel door frame member, and a horizontal front panel door frame member,
wherein the second vertical front panel door frame member and the horizontal front panel door frame member each comprise an inset portion configured to receive a portion of the door when the door is in a closed state,
wherein the second vertical front panel door frame member further comprises a retractable component that is configured to protrude beyond the second vertical front panel door frame member and lock the door in the closed state;
wherein the door comprises a top horizontal door frame member;
wherein the top horizontal door frame member comprises a depression; and
wherein the retractable component is configured to lock the door in the closed state by blocking the depression from vertical movement beyond the retractable component; and
at least two side panels, wherein each of the two side panels are configured to couple to the front panel via a hinge.

14. The pet barrier of claim 13, wherein each of the portion of the door configured to be received by the inset portion of the second vertical front panel door frame member and the portion of the door configured to be received by the inset portion of the horizontal front panel door frame member is a retractable peg.

15. The pet barrier of claim 14, wherein the front panel comprises at least one support at approximately the middle of a bottom side of the front panel to keep the door square within the first vertical front panel door frame member, the second vertical front panel door frame member, and the horizontal front panel door frame member such that each inset portion engages the corresponding retractable peg when the door is in the closed position.

16. The pet barrier of claim 13, wherein the hinge comprises a plurality of fixed stops at a plurality of angles.

17. A freestanding pet barrier comprising:
a plurality of hinges,
wherein each of the plurality of hinges comprises a first component configured to engage a second component,
wherein the first component comprises one or more projections,
wherein the second component comprises a plurality of openings at a plurality of angles, and
wherein one or more of the plurality of openings are configured to engage and lock the one or more projections at one of the plurality of angles;
a front panel; and
two side panels, wherein each of the two side panels is configured to couple to the front panel at one of the plurality of angles via one of the plurality of hinges, wherein freestanding pet barrier is configured to form an open configuration that is self-supporting in use, and wherein a plan view of the freestanding pet barrier in the open configuration defines a non-enclosing figure.

18. The freestanding pet barrier of claim 17, wherein each of the first component and the second component comprise a connection member, wherein the connection member of the first component is configured to couple to one of the two side panels and the connection member of the second component is configured to couple to the front panel, and wherein the connection member of the first component and the connection member of the second component are positioned on the first component and the second component respectively so as to prevent the one of the two side panels from moving beyond 180 degrees relative to the front panel.

19. The freestanding pet barrier of claim 17, further comprising a plurality of bottom hinges, wherein each of the plurality of bottom hinges is continuously adjustable, and wherein each of the two side panels is further configured to couple to the front panel via one of the plurality of bottom hinges.

20. The freestanding pet barrier of claim 17, wherein the one or more projections on the first component equal the plurality of openings on the second component, and wherein each of the one or more projections on the first component and the plurality of openings the second component are approximately equally spaced from the next.
